(19) United States
(12) Patent Application Publication
(10) Pub. No.: US 2010/0294855 A1
(43) Pub. Date: Nov. 25, 2010

(54) PAINT SPRAYER WITH FRAME STEP

(76) Inventors: Dale D. Johnson, Shoreview, MN (US); Andrew J. Kopel, Stanchfield, MN (US); Steve J. Wrobel, Rogers, MN (US); Steven H. Fredrickson, Minneapolis, MN (US)

Correspondence Address: GRACO MINNESOTA INC, PO BOX 1441, MINNEAPOLIS, MN, 55440, US

(21) Appl. No.: 12/811,427

(22) PCT Filed: Jan. 12, 2009
(86) PCT No.: PCT/US09/30696

§ 371 Date: Jul. 1, 2010

Related U.S. Application Data
(60) Provisional application No. 61/020,507, filed on Jan. 11, 2008.

(51) Int. Cl. B05B 15/00; A47C 12/00

(52) U.S. Cl. 239/289

(57) ABSTRACT

This invention allows a painter to use a sprayer 12 to reach objects or surfaces that would otherwise be out of reach for them. A step 10 is provided on the sprayer 12 which provides a quick and easy solution for users when prepping and cleaning a room. This feature would easily allow an average sized man to reach the ceiling in an 8 foot room and other similar heights. In this function the step 10 would allow the sprayer frame 14 to act as a step stool or step ladder.

### TECHNICAL FIELD

This application claims the benefit of U.S. Application Ser. No. 61/020,507, filed Jan. 11, 2008, the contents of which are hereby incorporated by reference.

### BACKGROUND ART

Paint sprayers and other related items such as airless sprayers, air assisted airless sprayers, texture sprayers, HVLP sprayers, pressure washers and line stripers (collectively referred to as paint sprayers) are commonly used in construction work and at times may require the use of a ladder to extend the operator's reach.

### DISCLOSURE OF THE INVENTION

It is an object of this invention to allow the painter to use the sprayer to reach objects or surfaces that would otherwise be out of reach for them. This sprayer would provide an all in one convenience and the construction is suitable for any product that is portable and requires a frame. The step on the sprayer would provide a quick and easy solution for users when prepping and cleaning a room. This feature would easily allow an average sized man to reach the ceiling in an 8 foot room and other similar heights. In this function the step would allow the sprayer frame to act as a step stool or step ladder.

Also, this feature could serve as a small bench, table, chair, stool, etc. and could have integrated tip holders, tool storage, etc. The proposed invention consists of a sprayer frame and a step that is placed on top of the sprayer frame. The step may be permanent, movable, or removable. Following are some possible configurations:

Step is permanently attached to the sprayer frame. In this configuration, the step could be attached to the frame by welding, glue, rivets, screws, or by a similar process. In this configuration the step could be attached to the top of the sprayer. Also, the step could be attached a side or the bottom of the sprayer where the sprayer would be turned on its side or top to be used in “step stool” mode.

The step is detachable from the top of the sprayer frame. In this configuration the step could be attached to the frame by screws or by a similar known mechanism.

The step is attached as a hinge on one side which allows it to pivot out of the way of the controls.

The step is attached to a pivot pin which allows the step to rotate out of the way during use.

The step is attached to a rail or multiple rails that allow it to be pushed out of the way. In this configuration the step may be one large piece or several small pieces. In the several small piece configuration the “step-lets” would nest under or over each other which would store the step in a small package. The single piece configuration would have slides that attach to the frame or separate rails. These slides would allow the step to slide out of the way.

The step is removable by snap fit. The step could be made out of plastic injection mold, die cast aluminum, extruded aluminum, or other similar techniques where the snaps are part of the step. In an alternative configuration the steps could have a pre-manufactured snap attached to them, or another part that would act as a snap. Provisions may or may not be provided to snap the step back onto the frame.

The step is removable by hand screws. The step could be fastened into place with large hand screws that could be removed by hand to allow the step to be removed. Provisions may or may not be provided to attach the step back onto the frame.

In all configurations for the step, the sprayer handle may or may not be an integral part of the step or components used to attach the step to the sprayer such as a rail or hinge. Also, in all configurations, the sprayer may be part of one step or multiple steps.

By definition a sprayer frame is the structural component of a pumping system that acts as a foundation for the pump system to mount to. The sprayer frame may or may not have wheels.

The step does not need to be a separate component and could be a feature of another part attached to the sprayer such as a tool box lid, tip holder, control box cover, motor cover, etc. Also, the step could be an accessory used by the sprayer like a gun, pole extension, paint roller, paint tray, spray hose, etc.

Also, claimed in this invention are features to keep the step from sliding around once it is set in the “step stool” configuration. The features may include, but are not limited to snaps, holes in the frame, rails on the frame, cavities designed to closely fit the handle or other features, etc.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a view of a paint sprayer without the step in place.

FIG. 2 is a view of a paint sprayer with the step in place.

FIG. 3 is a view of a paint sprayer with the step in place being used.

FIG. 4 is a view of a paint sprayer with the step being stored on the side.

FIG. 5 is a view of a paint sprayer with the step being stored on the end.

FIG. 6 shows an alternate embodiment of the instant invention.

FIG. 7 shows another alternate embodiment of the instant invention.

FIG. 8 shows another alternate embodiment of the instant invention.

FIG. 9 shows another alternate embodiment of the instant invention.

FIG. 10 shows another alternate embodiment of the instant invention.

FIG. 11 shows another alternate embodiment of the instant invention.

FIG. 12 shows another alternate embodiment of the instant invention.

FIG. 13 shows another alternate embodiment of the instant invention.

FIG. 14 shows another alternate embodiment of the instant invention.

FIG. 15 shows another alternate embodiment of the instant invention.

FIG. 16 shows another alternate embodiment of the instant invention.

FIG. 17 shows another alternate embodiment of the instant invention.

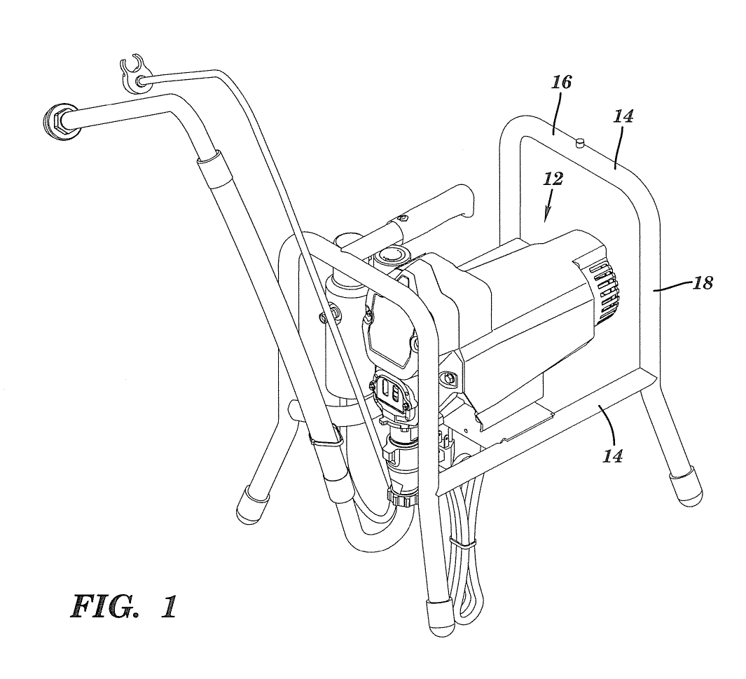

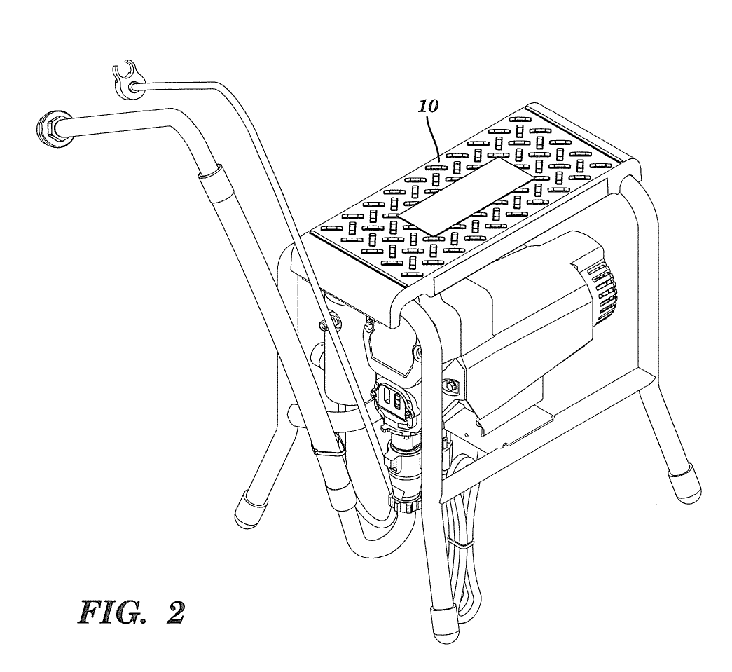

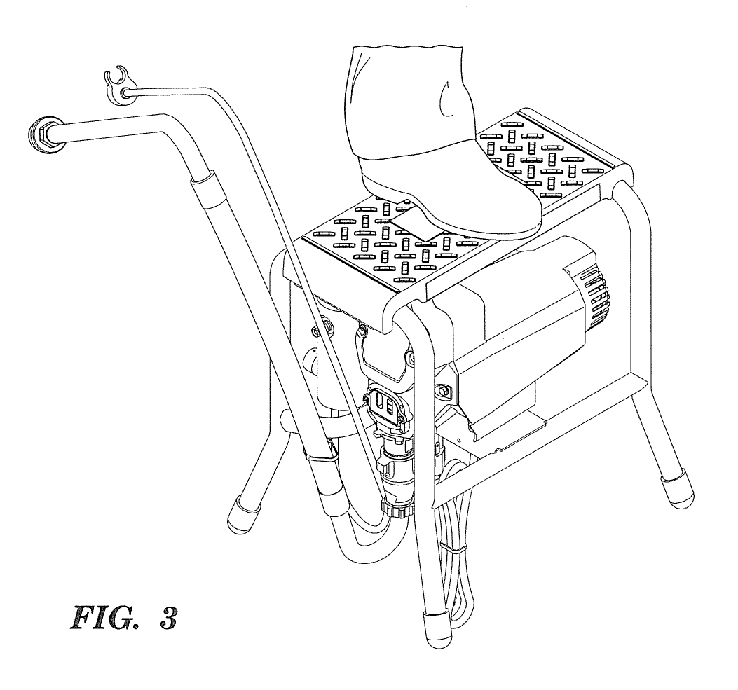

### BEST MODE FOR CARRYING OUT THE INVENTION

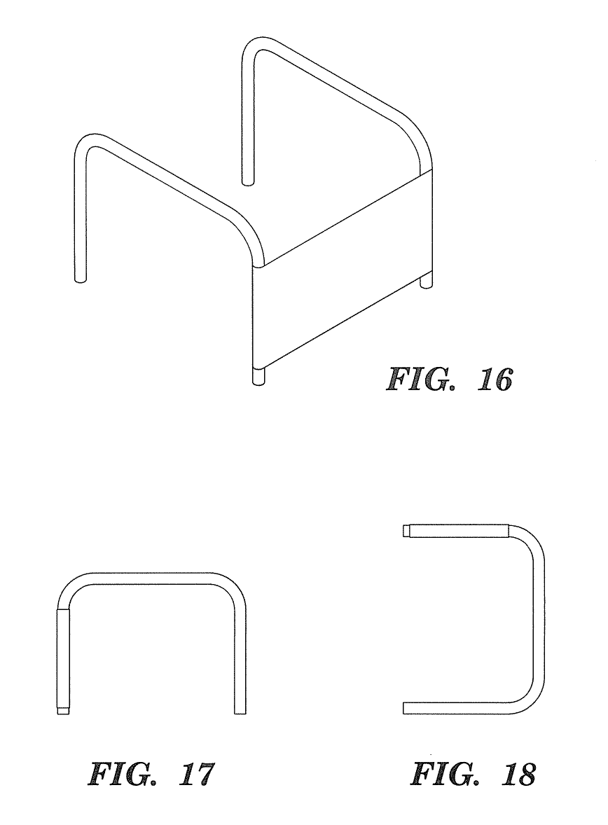

In the simplest embodiment, step 10 is permanently attached to the sprayer 12 frame 14. In this configuration, the step 10 could be attached to the frame 14 and horizontal or vertical frame rails 16 and 18 respectively, by welding, glue, rivets, screws, or by a similar process. While the step 10 could be attached to the top of the sprayer frame 14, it could also be attached a side (see FIG. 16) or the bottom of the sprayer 12 where the sprayer 12 would be turned on its side or top to be used in “step stool” mode.

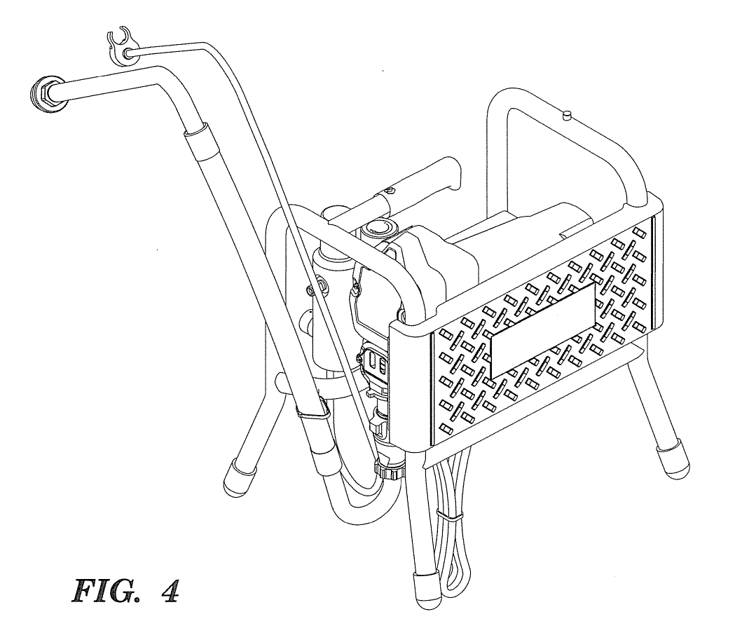

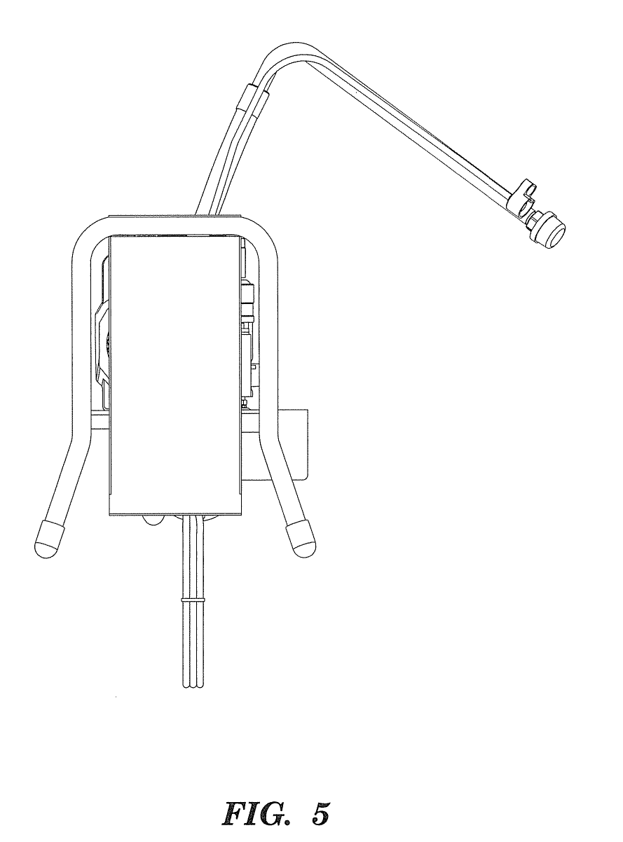

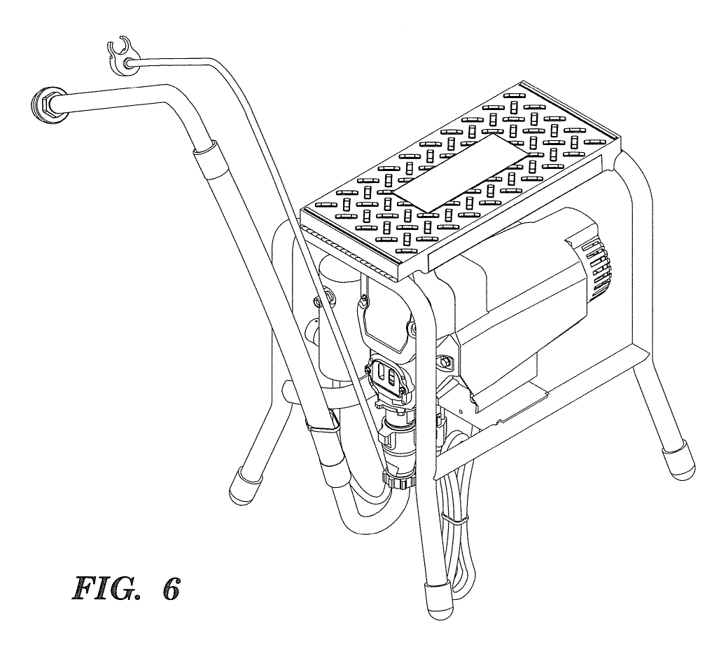

In another embodiment, the step 10 is detachable from the top of the sprayer frame 14. In this configuration the step 10 could be attached to the frame 14 by screws or by a similar known mechanism. In the preferred embodiment, the step 10 is stored horizontally on the side by attaching it to vertical frame rails 18 as shown in FIG. 4.

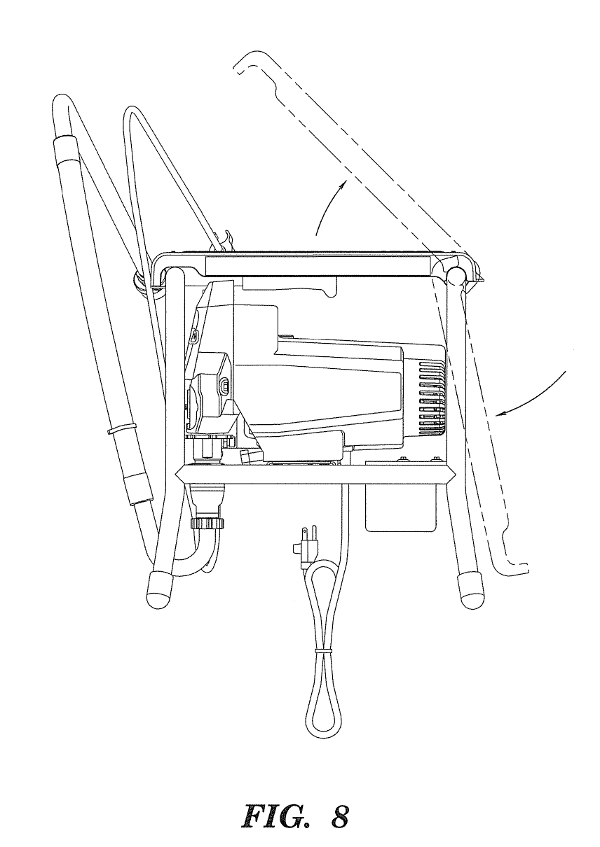

In another embodiment, the step 10 is attached as a hinge on one side which allows it to pivot out of the way of the controls. (FIG. 8)

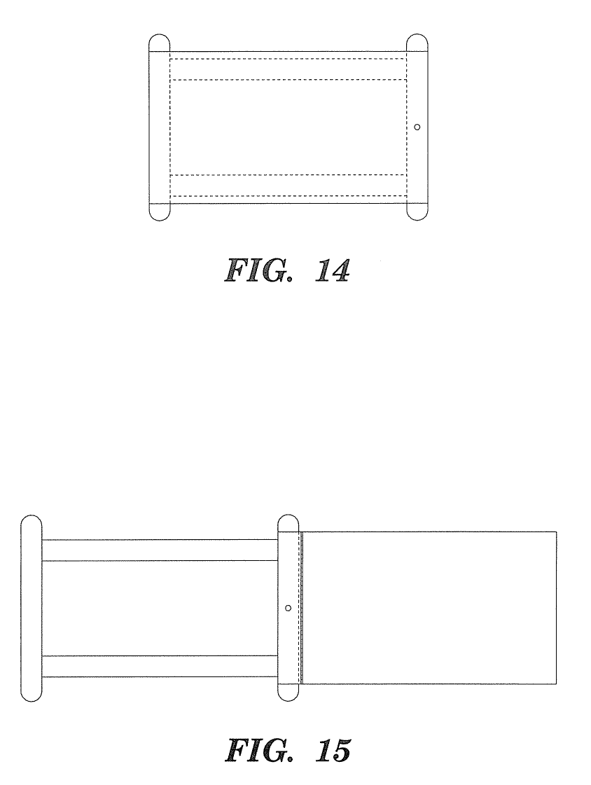

In another embodiment, the step 10 is attached to a pivot pin which allows the step to rotate out of the way during use. (Figure 14)

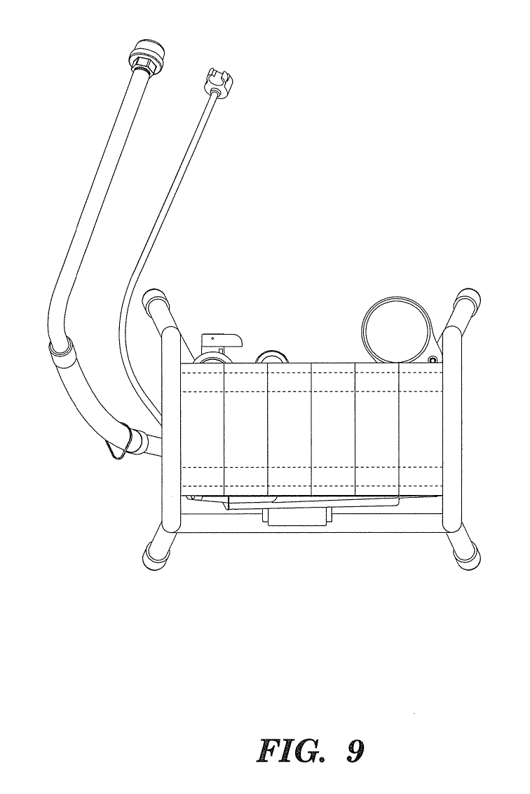

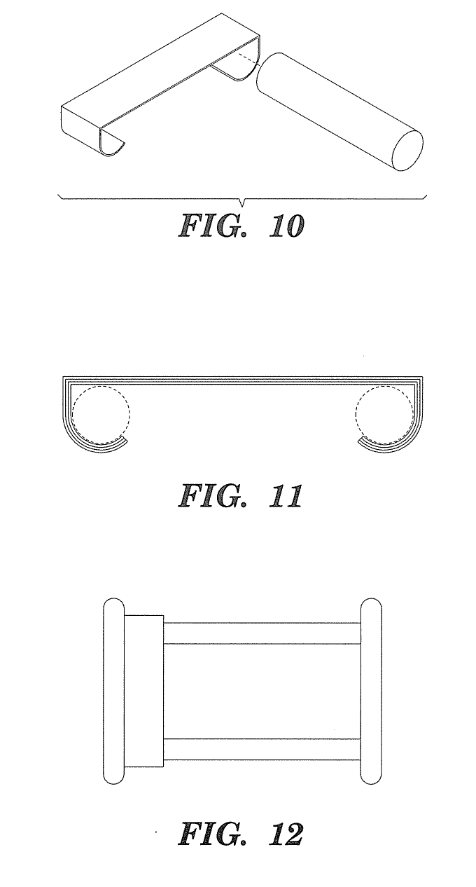

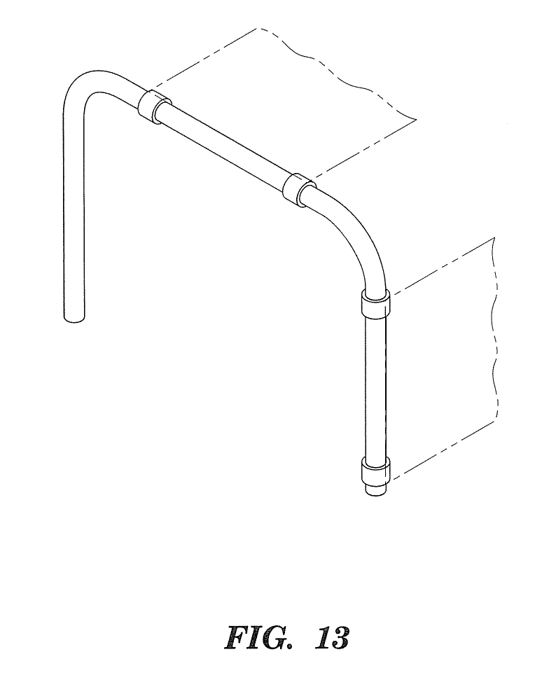

In another embodiment, the step 10 is attached to a rail or multiple rails that allow it to be pushed out of the way. In this configuration the step 10 may be one large piece or several small pieces. In the several small piece configuration the “step-lets” would nest under or over each other which would store the step in a small package. The single piece configuration would have slides that attach to the frame or separate rails. These slides would allow the step to slide out of the way. (FIGS. 9-12)

The step may be removable by snap fit. The step could be made out of plastic injection mold, die cast aluminum, extruded aluminum, or other similar techniques where the snaps are part of the step. In an alternative configuration the steps could have a pre-manufactured snap attached to them, or another part that would act as a snap. Provisions may or may not be provided to snap the step back onto the frame.

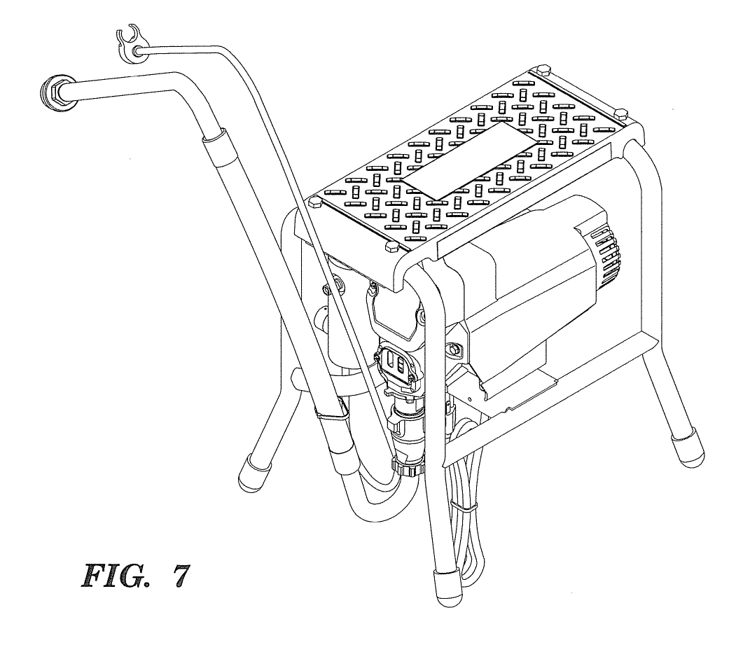

Also, the step may be removable by hand screws. The step could be fastened into place with large hand screws that could be removed by hand to allow the step to be removed. Provisions may or may not be provided to attach the step back onto the frame. (Figure 7)

In all configurations for the step, the sprayer handle may or may not be an integral part of the step or components used to attach the step to the sprayer such as a rail or hinge. Also, in all configurations, the sprayer may be part of one step or multiple steps. By definition a sprayer frame is the structural component of a pumping system that acts as a foundation for the pump system to mount to. The sprayer frame may or may not have wheels.

The step does not need to be a separate component and could be a feature of another part attached to the sprayer such as a tool box lid, tip holder, control box cover, motor cover, etc. Also, the step could be an accessory used by the sprayer like a gun, pole extension, paint roller, paint tray, spray hose, etc.

Also, claimed in this invention are features to keep the step from sliding around once it is set in the “step stool” configuration. The features may include, but are not limited to snaps, holes in the frame, rails on the frame, cavities designed to closely fit the handle or other features, etc.

It is contemplated that various changes and modifications may be made to the sprayer step without departing from the spirit and scope of the invention as defined by the following claims.

1. A sprayer for use in applying a material, said sprayer having a frame and comprising:
at least one frame rail; and
a step locatable on at said at least one frame rail, said step being sized and of sufficient strength to support an operator of said sprayer.
